(19) United States
(12) Patent Application Publication
(10) Pub. No.: US 2006/0094323 A1
(43) Pub. Date: May 4, 2006

(54) Apparatus to form dielectric layer and method of manufacturing plasma display panel (PDP) with the apparatus

(76) Inventors: Chong-Gi Hong, Suwon-si (KR); Tae-Kyoung Kang, Suwon-si (KR)

Correspondence Address: Robert E. Bushnell, Suite 300, 1522 K Street, N.W., Washington, DC, 20005-1202, US

(21) Appl. No.: 11/211,581

(22) Filed: Aug. 26, 2005

(30) Foreign Application Priority Data
Nov. 4, 2004 (KR) 10-2004-0089224

(51) Int. Cl. H01J 9/00; H01J 9/24

(52) U.S. Cl. 445/24

(57) ABSTRACT

In an apparatus to manufacture a dielectric layer that can reduce a spreading process of the dielectric layer, and a method of manufacturing a Plasma Display Panel (PDP) with reduced manufacturing time using the apparatus, the apparatus includes: a surface plate adapted to receive a substrate; a slot die adapted to move in two directions above the surface plate; a nozzle arranged on one end of the slot die and adapted to spread a coating fluid on top of the substrate to form the dielectric layer; a coating fluid tank adapted to store the coating fluid to be supplied to the nozzle of the slot die; and a coating fluid pump adapted to supply the coating fluid from the coating fluid tank to the nozzle of the slot die.

### CLAIM OF PRIORITY

This application makes reference to, incorporates the same herein, and claims all benefits accruing under 35 U.S.C. § 119 from an application for APPARATUS FOR FORMING DIELECTRIC LAYER AND METHOD OF MANUFACTURING PLASMA DISPLAY PANEL USING THE APPARATUS earlier filed in the Korean Intellectual Property Office on the 4 of Nov., 2004 and there duly assigned Serial No. 10-2004-0089224.

### BACKGROUND OF THE INVENTION

1. Field of the Invention

The present invention relates to an apparatus to form a dielectric layer and a method of manufacturing a Plasma Display Panel (PDP) with the apparatus, and more particularly, to an apparatus to form a dielectric layer of a desired width by a single dielectric layer spreading process, and a method of manufacturing a PDP in a short period of time by a simple process using the apparatus.

2. Description of the Related Art

A PDP normally includes a front panel and a rear panel. The front panel includes a front substrate, a plurality of pairs of sustaining discharge electrodes, each pair including an X electrode and a Y electrode formed on a rear surface of the front substrate, and a top dielectric layer covering the pairs of sustaining discharge electrodes. The top dielectric layer is covered by a protective layer typically made of MgO.

The rear panel includes a rear substrate, address electrodes formed on a rear surface of the rear substrate to cross the sustaining discharge electrodes formed on the front substrate, a bottom dielectric layer covering the address electrodes, barrier ribs formed on the bottom dielectric layer and defining discharge cells together with the pairs of sustaining discharge electrodes, and a fluorescent layer formed on the walls of the barrier ribs and the top surface of the bottom dielectric layer.

To manufacture the front panel of the PDP noted above, the X and Y electrodes are formed in a predetermined pattern on the front substrate. Transparent electrodes included in the X and Y electrodes are formed by, for example, photo etching a material such as ITO. Bus electrodes included in the X and Y electrodes are formed by photo etching or photosensitive pasting a multi-layer structure made of Cr/Cu/Cr or Cr/Al/Cr or other structures.

After the pairs of sustaining discharge electrodes are formed on the front substrate, a dielectric material is screen printed on the front substrate, thereby forming the dielectric layer 80. A screen mask is disposed above the front substrate, and a squeezer is used as a paint brush to screen print a dielectric paste, to form the dielectric layer. The screen mask is a gauze made of a SUS material having a uniform width. The dielectric paste passes through the screen mask, and is spread on the front substrate in a uniform thickness. Then, after the spreading of the dielectric layer is completed, the dielectric layer is dried and subjected to a calcination process.

Generally, the thickness of the top dielectric layer formed on the front panel needs to be about 40 μm. Since, this thickness cannot be achieved through a single spreading of the dielectric paste using the screen printing method, the spreading, drying, and calcination processes must be repeated two or three times. Thus, there is a need to develop an apparatus for forming a dielectric layer in a short time and a method of manufacturing a PDP using the apparatus.

### SUMMARY OF THE INVENTION

The present invention provides an apparatus to form a dielectric layer with reduced time to perform a spreading process of the dielectric layer, and a method of manufacturing a Plasma Display Panel (PDP) using the apparatus so that the overall manufacturing time is shortened.

The present invention also defines a range of the thickness of a top dielectric layer needed for a PDP to operate normally, and provides a method of quickly manufacturing the PDP having the top dielectric layer with a thickness within the range.

According to one aspect of the present invention, an apparatus to form a dielectric layer is provided, the apparatus comprising: a surface plate adapted to receive a substrate; a slot die adapted to move in two directions above the surface plate; a nozzle arranged on one end of the slot die and adapted to spread a coating fluid on top of the substrate to form the dielectric layer; a coating fluid tank adapted to store the coating fluid to be supplied to the nozzle of the slot die; and a coating fluid pump adapted to supply the coating fluid from the coating fluid tank to the nozzle of the slot die.

The apparatus further comprises a vacuum pump connected to the surface plate and adapted to fix the substrate to the surface plate by a vacuum suction.

The apparatus further comprises a controller adapted to control a motion of the slot die and a spreading pressure of the coating fluid ejected from the nozzle.

According to another aspect of the present invention, a method of manufacturing a Plasma Display Panel (PDP) is provided, the method comprising: arranging a substrate with electrodes formed thereon on a surface plate, and fixing the substrate on the surface plate; forming a dielectric layer by spreading a dielectric material on the substrate to a predetermined thickness using a coater to eject a material having a predetermined viscosity; and calcinating the dielectric layer.

In forming the dielectric layer, the dielectric layer is spread so that a thickness of the dielectric layer in a display region of the substrate and a thickness of the dielectric layer in a non-display region of the substrate are different from each other.

The thickness of the dielectric layer spread in the display region is within a range of 24-50 μm.

A thickness of the dielectric layer in a non-display region at a beginning of the spreading of the dielectric layer is thinner than the thickness of the dielectric layer in the display region and thicker than a thickness of the dielectric layer in another non-display region at an end of the spreading of the dielectric layer.

A thickness of the dielectric layer in a non-display region at a beginning of the spreading of the dielectric layer is thinner than the thickness of the dielectric layer in the display region and thicker than a thickness of the dielectric layer in another non-display region at an end of the spreading of the dielectric layer.

The thickness of the dielectric layer in the non-display region at the beginning of the spreading of the dielectric layer is within a range of 20-48 μm.

The thickness of the dielectric layer in the non-display region at the end of the spreading of the dielectric layer is within a range of 36-54 μm.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar componants, wherein:

FIG. 1 is a partially cutaway exploded perspective view of a Plasma Display Panel (PDP);

FIG. 2 is a schematic view of a method of manufacturing a front panel of the PDP of FIG. 1;

FIG. 3 is a view of a method of manufacturing a dielectric layer with an apparatus to form the dielectric layer according to an embodiment of the present invention; and

FIG. 4 is a view of a thickness variation of a dielectric layer formed by the method and apparatus of FIG. 3.

### DETAILED DESCRIPTION OF THE INVENTION

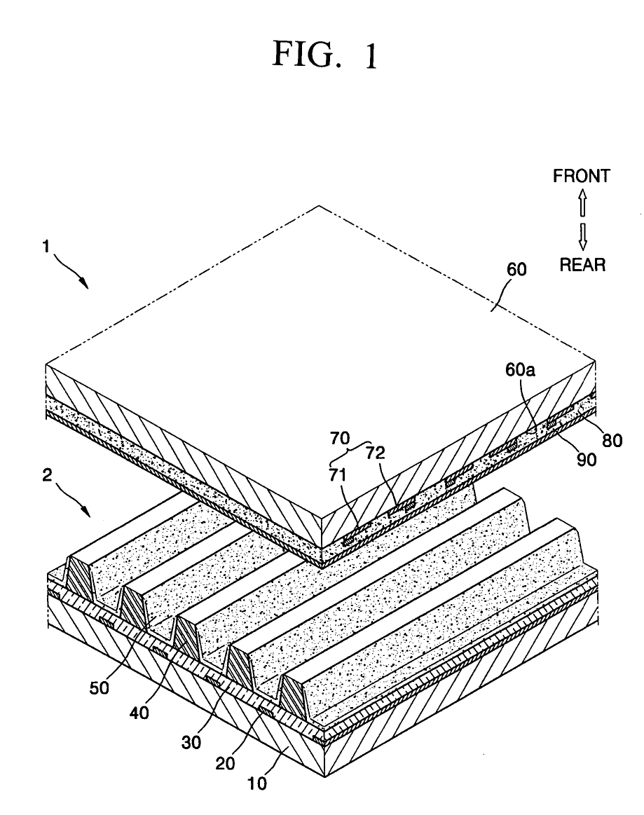

FIG. 1 is a partially cutaway exploded perspective view of a PDP. Referring to FIG. 1, the PDP includes a front panel 1 and a rear panel 2. The front panel 1 includes a front substrate 60, a plurality of pairs of sustaining discharge electrodes 70, each pair including an X electrode 71 and a Y electrode 72 formed on a rear surface 60a of the front substrate 60, and a top dielectric layer 80 covering the pairs of sustaining discharge electrodes 70. The top dielectric layer 80 is covered by a protective layer 90 typically made of MgO.

The rear panel 2 includes a rear substrate 10, address electrodes 20 formed on a rear surface of the rear substrate 10 to cross the sustaining discharge electrodes 70 formed on the front substrate 60, a bottom dielectric layer 30 covering the address electrodes 20, barrier ribs 40 formed on the bottom dielectric layer 30 and defining discharge cells together with the pairs of sustaining discharge electrodes 70, and a fluorescent layer 50 formed on the walls of the barrier ribs 40 and the top surface of the bottom dielectric layer 30.

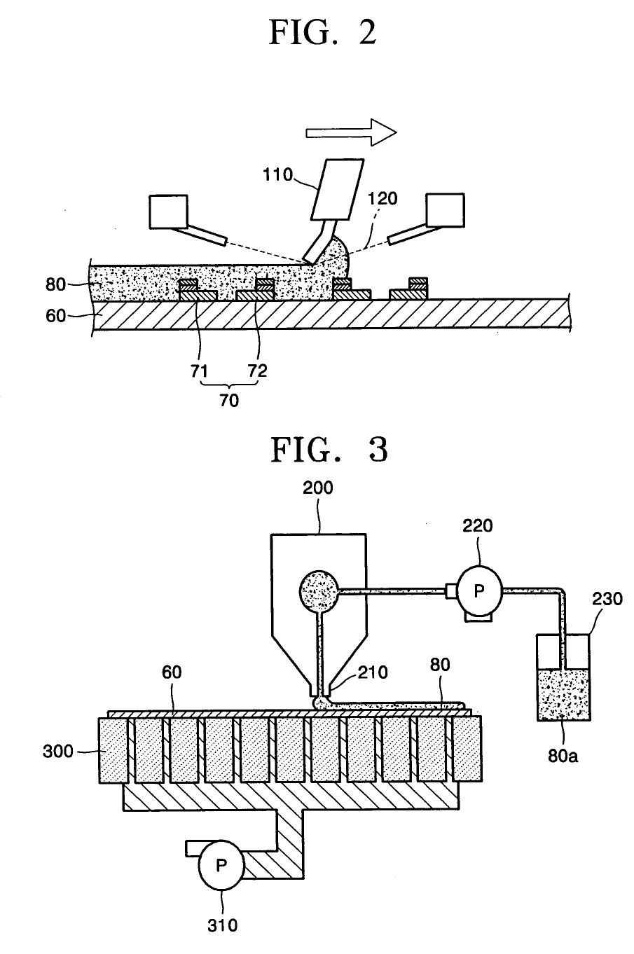

FIG. 2 is a schematic view of a method of manufacturing the front panel 60 of the PDP of FIG. 1.

As illustrated in FIG. 2, first, the X and Y electrodes 71 and 72 are formed in a predetermined pattern on the front substrate 60. Transparent electrodes included in the X and Y electrodes 71 and 72 are formed by, for example, photo-etching a material such as Indium-Tin-Oxide (ITO). Bus electrodes included in the X and Y electrodes 71 and 72 are formed by photo-etching or photosensitive pasting a multi-layer structure made of Cr/Cu/Cr or Cr/Al/Cr or other structures.

After the pairs of sustaining discharge electrodes 70 are formed on the front substrate 60, a dielectric material is screen printed on the front substrate 60, thereby forming the dielectric layer 80. As illustrated in FIG. 2, a screen mask 120 is disposed above the front substrate 60, and a squeezer 110 is used as a paint brush to screen print a dielectric paste, to form the dielectric layer 80. The screen mask 120 is a gauze made of a SUS material having a uniform width. The dielectric paste passes through the screen mask 120, and is spread on the front substrate 60 in a uniform thickness. Then, after the spreading of the dielectric layer 80 has been completed, the dielectric layer 80 is dried and subjected to a calcination process.

Generally, the thickness of the top dielectric layer 80 formed on the front panel 60 needs to be about 40 μm. Since this thickness cannot be achieved through a single spreading of the dielectric paste using the screen printing method, the spreading, drying, and calcination processes must be repeated two or three times. Thus, there is a need to develop an apparatus to form a dielectric layer in a short time and a method of manufacturing a PDP with the apparatus.

The present invention is described more fully below with reference to the accompanying drawings, in which exemplary embodiments of the present invention are shown. Like reference numerals in the drawings denote like elements.

FIG. 3 is a view of a method of manufacturing a dielectric layer with an apparatus to form the dielectric layer according to an embodiment of the present invention.

As illustrated in FIG. 3, the apparatus includes a surface plate 300 and a coater. The surface plate 300 is a stage on which a front substrate 60 is disposed, and a dielectric layer 80 is to be formed on the front substrate 60. The surface plate 300 includes a vacuum pump 310 so that the front substrate 60 is fixed onto the surface plate 300 by a vacuum suction. The coater includes a coating fluid supply tank 230, to supply a coating fluid 80a to form the dielectric layer 80, a slot die 200 including a nozzle 210 to spread the coating fluid on the front substrate 60, and a coating fluid supply pump 220 to supply the coating fluid from the coating fluid supply tank 230 to the slot die 200. A plurality of slot dies 200 can be installed along the length of the surface plate 300, and the nozzle 210 can have a wide exit so that the dielectric layer 80 can be formed in the direction along which the nozzle 210 moves. The slot die 200 forms the dielectric layer 80 on the front substrate 60 disposed on the surface plate 300 while moving along the length of the surface plate 300. Although not illustrated in FIG. 3, a controller can be further installed in the coater to control the movement of the slot die 200 of the coater, the pressure being applied when spreading the dielectric layer, etc.

The dielectric layer 80 is formed by the following method using the apparatus having the structure described above.

First, the front substrate 60 is disposed on the surface plate 300, and the front substrate 60 is fixed onto the surface plate 300 by the vacuum suction. Then, the thickness of substrate 60 is fixed onto the surface plate 300 by the vacuum suction. Then, the thickness of the front substrate 60 is measured and the height of the nozzle 210 is determined considering the thickness of the dielectric layer 80 that is to be formed. The coating fluid is supplied to the slot die 200 via the coating fluid supply pump 220, and the coating fluid starts to pass through the nozzle 210 and is spread at a predetermined pressure on the front substrate 60. During the spreading process, the nozzle 210 can move along the length of electrodes (not shown) disposed on the front substrate 60. Since a dielectric layer formed on a front substrate of a PDP is typically around 40 μm thick and a dielectric layer formed on a rear substrate is about 15 μm thick, the apparatus of the present invention uses the coater to form the dielectric layer 80 on the front substrate 60 in a single spreading process. As such, the overall time for manufacturing a PDP using the apparatus and method of the present invention is reduced.

Also, if the thickness of the dielectric layer 80 is reduced, the manufacturing cost is reduced since less dielectric material is used. However, when forming the dielectric layer 80 to a thickness below 24 μm, an inner voltage of the dielectric layer 80 is lowered and the dielectric layer can be damaged. To prevent this problem, the inner voltage needs to be at least 800 V and an surface roughness needs to be below 2 μm thick. Based on the experimental data in Table 1, the thickness of a dielectric layer 80 spread by the coater can be within the range of 24-50 μm.

TABLE 1

| Thickness of Dielectric | Inner voltage | Surface roughness |
|---|---|---|
| Layer (μm) | (V) | (μm) |
| 20 | 692 | 0.3 |
| 22 | 775 | 0.4 |
| 24 | 807 | 0.4 |
| 26 | 821 | 0.4 |
| 28 | 863 | 0.5 |
| 30 | 922 | 0.5 |
| 32 | 942 | 0.6 |
| 34 | 1000 | 0.7 |
| 36 | 1060 | 0.9 |
| 38 | 1205 | 1 |
| 40 | 1241 | 1.3 |
| 42 | 1263 | 1.5 |
| 44 | 1248 | 1.6 |
| 46 | 1296 | 1.8 |
| 48 | 1302 | 1.9 |
| 50 | 1310 | 2 |
| 52 | 1324 | 4 |
| 54 | 1335 | 6 |

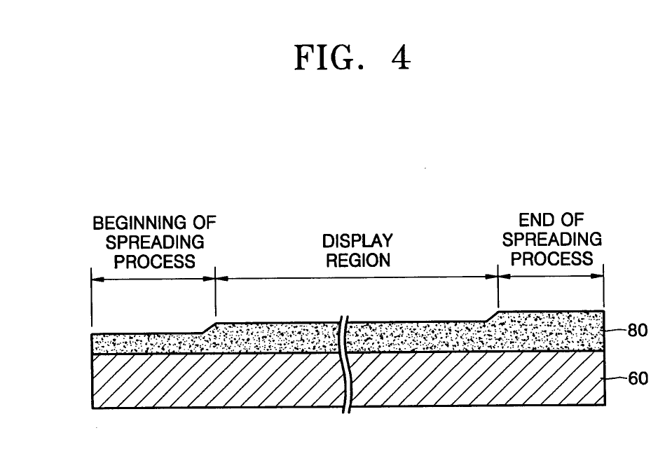

FIG. 4 is a view of a thickness variation of a dielectric layer formed with the method and apparatus of FIG. 3.

As illustrated in FIG. 4, the dielectric layer is spread thinly by the coater at the beginning of the spreading process as compared to a display region corresponding to the center portion of a PDP and at the end of the spreading process. The dielectric layer is spread to have different thicknesses because it is difficult to control the thickness of the dielectric layer to be of a desired thickness at the beginning and end of the spreading process due to a fillet effect when forming the dielectric layer of a desired width. Thus, the spreading process is designed so that the thickness of the dielectric layer is within a desired range in the display region. By designing the spreading process so as to change the thickness of the dielectric layer, the formation of an overly thick or thin dielectric layer in the display region can be prevented.

When designing the spreading process to form the thickness of a non-display region bordering the display region to be different to the thickness of the display region from the beginning, the thickness of the dielectric layer at the beginning does not need to be thin or the thickness of the dielectric layer at the end does not need to be thick. However, to make the thickness of the dielectric layer of the display region be within the range of 24-50 μm described above, the spreading process must be designed such that the thickness of the dielectric layer at the beginning of the spreading process is within the range of 20-48 μm and the thickness of the dielectric layer at the end of the same process is within the range of 36-54 μm so that a thickness error of the dielectric layer in the display region can be reduced. Since the thickness of the dielectric layer in the start and end regions of the spreading process is not important, the thickness of dielectric layer in the start and end regions can be set not to be within the range of 24-50 μm as long as the thickness of the dielectric layer is in the range of 24-50 μm in the display region.

The dielectric layer can be made of a lead glass or a glass of a bismuth family. A lead glass including 60-65 parts by weight of PbO, 10-15 parts by weight of B₂O₃, 10-15 parts by weight of SiO₂, 1-5 parts by weight of ZnO, and 1-5 parts by weight of Al₂O₃ can be used.

A glass of the bismuth family including 10-20 parts by weight of B₂O₃, 0-5 parts by weight of SiO₂, 30-40 parts by weight of ZnO, and 20-30 parts by weight of Bi₂O₃ can also be used.

Alternatively, a glass including 15-25 parts by weight of B₂O₃, 0-8 parts by weight of SiO₂, 30-40 parts by weight of ZnO, 20-30 parts by weight of Bi₂O₃, and 7-17 parts by weight of CaO with some Na2O can be used.

Although, the components of the glass are not limited to the elements described above, a softening point of the glass can be adjusted by controlling the composition ratio. For example, B₂O₃ has low oxygen-metal bonding force. If the ratio of B₂O₃ is increased, the softening point of the glass is lowered, and if the ratio of B₂O₃ is decreased, the softening point of the glass is raised.

According to an apparatus and method of the present invention described above, a dielectric layer having a desired thickness can be spread by a single spreading process, thereby reducing the cost and time of a manufacturing process for a PDP. In addition, the spreading process can be designed to spread the dielectric layer to have different thicknesses in non-display regions and a display region. Also, the thickness of the dielectric layer in the display region can be kept within a predetermined range by using a coater.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. An apparatus to form a dielectric layer, the apparatus comprising:
a surface plate adapted to receive a substrate;
a slot die adapted to move in two directions above the surface plate;
a nozzle arranged on one end of the slot die and adapted to spread a coating fluid on top of the substrate to form the dielectric layer;
a coating fluid tank adapted to store the coating fluid to be supplied to the nozzle of the slot die; and
a coating fluid pump adapted to supply the coating fluid from the coating fluid tank to the nozzle of the slot die.

2. The apparatus of claim 1, further comprising a vacuum pump connected to the surface plate and adapted to fix the substrate to the surface plate by a vacuum suction.

3. The apparatus of claim 1, further comprising a controller adapted to control a motion of the slot die and a spreading pressure of the coating fluid ejected from the nozzle.

4. A method of manufacturing a Plasma Display Panel (PDP), the method comprising:
arranging a substrate with electrodes formed thereon on a surface plate, and fixing the substrate on the surface plate;
forming a dielectric layer by spreading a dielectric material on the substrate to a predetermined thickness using a coater to eject a material having a predetermined viscosity;
and calcinating the dielectric layer.

5. The method of claim 4, wherein in forming the dielectric layer, the dielectric layer is spread so that a thickness of the dielectric layer in a display region of the substrate and a thickness of the dielectric layer in a non-display region of the substrate are different from each other.

6. The method of claim 5, wherein the thickness of the dielectric layer spread in the display region is within a range of 24-50 μm.

7. The method of claim 5, wherein a thickness of the dielectric layer in a non-display region at a beginning of the spreading of the dielectric layer is thinner than the thickness of the dielectric layer in the display region and thicker than a thickness of the dielectric layer in another non-display region at an end of the spreading of the dielectric layer.

8. The method of claim 6, wherein a thickness of the dielectric layer in a non-display region at a beginning of the spreading of the dielectric layer is thinner than the thickness of the dielectric layer in the display region and thicker than a thickness of the dielectric layer in another non-display region at an end of the spreading of the dielectric layer.

9. The method of claim 7, wherein the thickness of the dielectric layer in the non-display region at the beginning of the spreading of the dielectric layer is within a range of 20-48 μm.

10. The method of claim 8, wherein the thickness of the dielectric layer in the non-display region at the beginning of the spreading of the dielectric layer is within a range of 20-48 μm.

11. The method of claim 7, wherein the thickness of the dielectric layer in the non-display region at the end of the spreading of the dielectric layer is within a range of 36-54 μm.

12. The method of claim 8, wherein the thickness of the dielectric layer in the non-display region at the end of the spreading of the dielectric layer is within a range of 36-54 μm.
